(19) United States
(12) Patent Application Publication
(10) Pub. No.: US 2010/0316425 A1
(43) Pub. Date: Dec. 16, 2010

(54) RECORDING MEDIUM CONVEYANCE MECHANISM CONNECTING APPARATUS, SHEET FINISHING APPARATUS, IMAGE FORMING APPARATUS AND RECORDING MEDIUM CONVEYING METHOD

(75) Inventors: Katsuya SASAHARA, Shizuoka (JP); Kikuo MIZUTANI, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/815,336

(22) Filed: Jun. 14, 2010

Related U.S. Application Data
(60) Provisional application No. 61/187,191, filed on Jun. 15, 2009.
(60) Provisional application No. 61/187,196, filed on Jun. 15, 2009.

(51) Int. Cl. G03G 15/00; B65H 9/00; B41F 13/66; B65H 5/02

(52) U.S. Cl. 399/410; 271/226; 270/58.08; 271/275

(57) ABSTRACT

A connecting apparatus includes a rotation conveyance section whose end is positioned below a recording medium discharge port of a recording medium discharging apparatus, and which is constructed separately from an inlet roller to nip and convey a recording medium and is rotated to receive and guide the recording medium discharged from the recording medium discharging apparatus to an inside of a recording medium receiving apparatus, and an upper conveyance mechanism whose end is positioned above the recording medium discharge port of the recording medium discharging apparatus and which is constructed separately from the inlet roller. An upper end of the connecting apparatus at a recording medium discharging apparatus side is positioned above the recording medium discharge port of the recording medium discharging apparatus, and a lower end is positioned below the recording medium discharge port of the recording medium discharging apparatus.

### CROSS-REFERENCE TO RELATED APPLICATIONS

This application is based upon and claims the benefit of priority from the prior U.S.A. Patent Application No. 61/187,191, filed on Jun. 15, 2009, and the prior U.S.A. Patent Application No. 61/187,196, filed on Jun. 15, 2009, the entire contents of which are incorporated herein by reference.

### TECHNICAL FIELD

The present invention relates to a recording medium conveyance mechanism connecting apparatus to absorb a difference in height between a recording medium discharging side apparatus and a recording medium receiving side apparatus, a sheet finishing apparatus including this recording medium conveyance mechanism connecting apparatus, an image forming apparatus and a recording medium conveying method.

### BACKGROUND

There is a case where an image forming apparatus is connected with a sheet finishing apparatus to perform stapling, punching, folding and the like. The image forming apparatus discharges a recording medium on which an image is formed, and the sheet finishing apparatus receives the discharged recording medium and performs specific processing.

Here, there is a case where the height of the recording medium discharged from the image forming apparatus deviates from the height of a reception port on the sheet finishing apparatus side due to unevenness of the floor surface on which the apparatus is installed and the design of the apparatus itself.

In this point, hitherto, a taper is provided on the reception port of the sheet finishing apparatus (see, for example, JP-A-11-171395, FIG. 1, reference numerals 1 and 2).

However, there is a problem that height difference which can be absorbed by providing the taper on the reception port has a limit.

### SUMMARY

It is an object of the present invention to provide a recording medium conveyance mechanism connecting apparatus to absorb a difference in height between a recording medium discharging side apparatus and a recording medium receiving, side apparatus, a sheet finishing apparatus including the recording medium conveyance mechanism connecting apparatus, an image forming apparatus and a recording medium conveying method.

In an aspect of the present invention, a recording medium conveyance mechanism connecting apparatus includes a rotation conveyance section whose end is positioned below a recording medium discharge port of a recording medium discharging apparatus, and which is constructed separately from an inlet roller to nip and convey a recording medium and is rotated to guide the recording medium to an inside of a recording medium receiving apparatus when the recording medium discharged from the recording medium discharging apparatus contacts the rotation conveyance section, and an upper conveyance mechanism whose end is positioned above the recording medium discharge port of the recording medium discharging apparatus and which is constructed separately from the inlet roller.

### DESCRIPTION OF THE DRAWINGS

FIG. 1 is a view showing a structure of an image forming apparatus and a sheet finishing apparatus of the invention.

FIG. 2 is a side view of a connecting apparatus of the invention.

FIG. 3 is a side view in which the connecting apparatus of the invention is seen from an arrow A side of FIG. 2.

FIG. 4 is a view showing a case where the position of a recording medium reception port of a sheet finishing apparatus of the invention is higher than the position of a recording medium discharge port of an image forming apparatus.

FIG. 5 is a view showing a case where the position of the recording medium reception port of the sheet finishing apparatus of the invention is lower than the position of the recording medium discharge port of the image forming apparatus.

FIG. 6 is a side view of a connecting apparatus of a first applied example of the invention.

FIG. 7 is a side view of a connecting apparatus of a second applied example of the invention.

FIG. 8 is a side view of a connecting apparatus of a third applied example of the invention.

FIG. 9 is a side view of a connecting apparatus of a fourth applied example of the invention.

FIG. 10 is an enlarged side view of an upper guide roller and a lower guide roller of the invention.

### DETAILED DESCRIPTION

Throughout this description, the embodiments and examples shown should be considered as exemplars, rather than limitations on the apparatus and methods of the present invention.

Hereinafter, embodiments of a recording medium conveyance mechanism connecting apparatus of the invention, a sheet finishing apparatus including this recording medium conveyance mechanism connecting apparatus, an image forming apparatus and a recording medium conveying method will be described in detail with reference to the drawings. Here, the image forming apparatus includes a copying machine, a MFP (Multifunction Peripheral) and a printer.

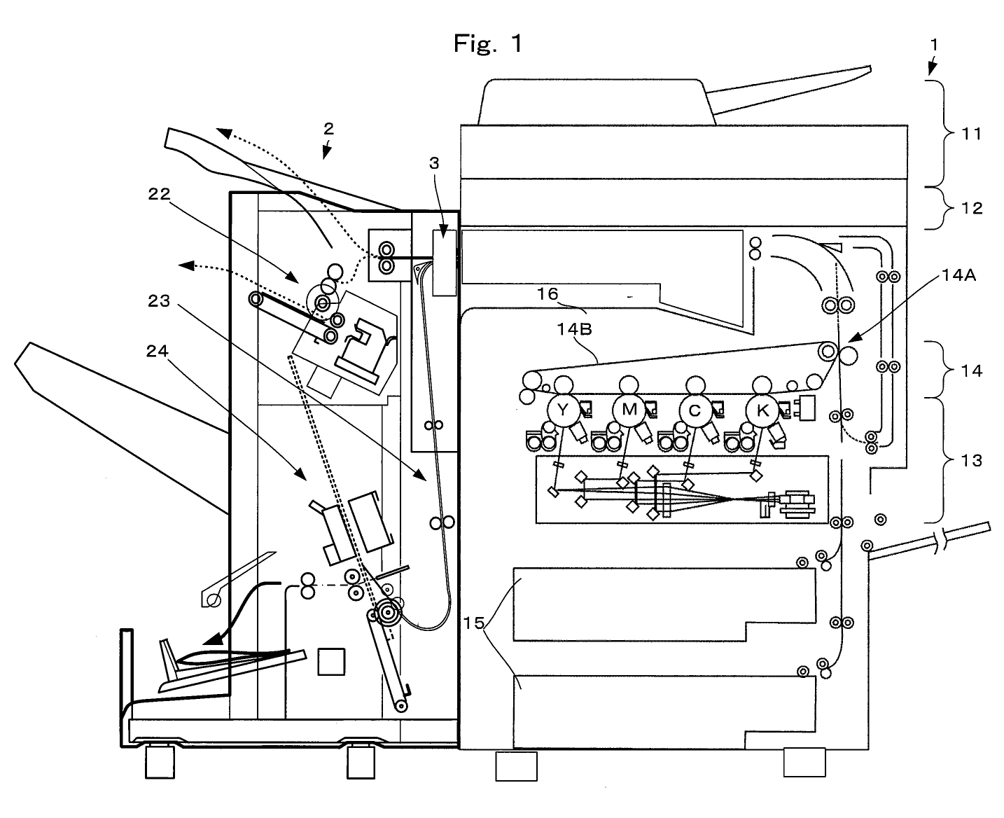

FIG. 1 is a view showing a structure of an image forming apparatus 1 and a sheet finishing apparatus 2 according to an embodiment. As shown in FIG. 1, the image forming apparatus 1 as a recording medium discharging apparatus includes an auto document feeder 11, an image reading section 12, an image forming section 13, a transfer section 14, a sheet conveyance mechanism and a paper feed unit 15.

The auto document feeder 11 is openably and closably provided at an upper part of a main body of the image forming apparatus 1. The auto document feeder 11 includes a document conveyance mechanism to take out documents one by one from a paper feed tray and conveys them to a storage tray.

The auto document feeder 11 conveys documents one by one to a document reading section of the image reading section 12 by a document conveyance mechanism. Besides, the auto document feeder 11 is opened and a document can be placed on a document table of the image reading section 12.

The image reading section 12 includes a carriage provided with an exposure lamp to expose a document and a first reflecting mirror, plural second reflecting mirrors installed on a main body frame of the image forming apparatus 1, a lens block, and a CCD (Charge Coupled Device) of an image reading sensor.

The carriage is at rest in the document reading section or reciprocates under the document table, and causes the first reflecting mirror to reflect the light of the exposure lamp reflected by the document. The plural second reflecting mirrors reflect the reflected light of the first reflecting mirror to the lens block. The lens block varies magnification of the reflected light and outputs it to the CCD. The CCD converts the incident light into an electric signal and outputs it as an image signal to the image forming section 13.

The image forming section 13 includes a laser irradiation unit, a photoconductive drum as an electrostatic latent image carrier and a developer supply unit for each of yellow Y, magenta M, cyan C and black K.

The laser irradiation unit irradiates a laser beam to the photoconductive drum based on the image signal, and forms an electrostatic latent image on the photoconductive drum. The developer supply unit supplies a developer to the photoconductive drum and forms a developer image from the electrostatic latent image.

The paper feed unit 15 takes out a recording medium one by one from a paper feed cassette and delivers it to the sheet conveyance mechanism. The sheet conveyance mechanism conveys the recording medium to the transfer section 14.

The transfer section 14 includes a transfer belt 14B, a transfer roller and a fixing device 14A. The transfer belt 14B as an image carrier transfers and carries the developer image of the photoconductive drum. The transfer roller applies a voltage and transfers the developer image on the transfer belt to the conveyed recording medium. The fixing device 14A heats and presses the developer image and fixes it to the recording medium.

The recording medium P discharged from a paper discharge port is stacked on the storage tray 16 as a support section to support a recording medium.

The sheet finishing apparatus 2 as a recording medium receiving apparatus includes a recording medium conveyance mechanism connecting apparatus (hereinafter referred to as a connecting apparatus 3) disposed to be opposite to the discharge port of the recording medium discharged from the image forming apparatus 1, a recording medium conveyance mechanism 23 to convey the recording medium, a punch and staple unit 22 to stack a prescribed number of recording media and to punch and staple the recording media, and a folding unit 24 to stack a prescribed number of recording media and to staple and fold the recording media.

The connecting apparatus 3 is disposed upstream of the sheet finishing apparatus 2 in the recording medium conveyance direction. The connecting apparatus 3 receives the recording medium discharged from the image forming apparatus 1 and guides it into the sheet finishing apparatus 2.

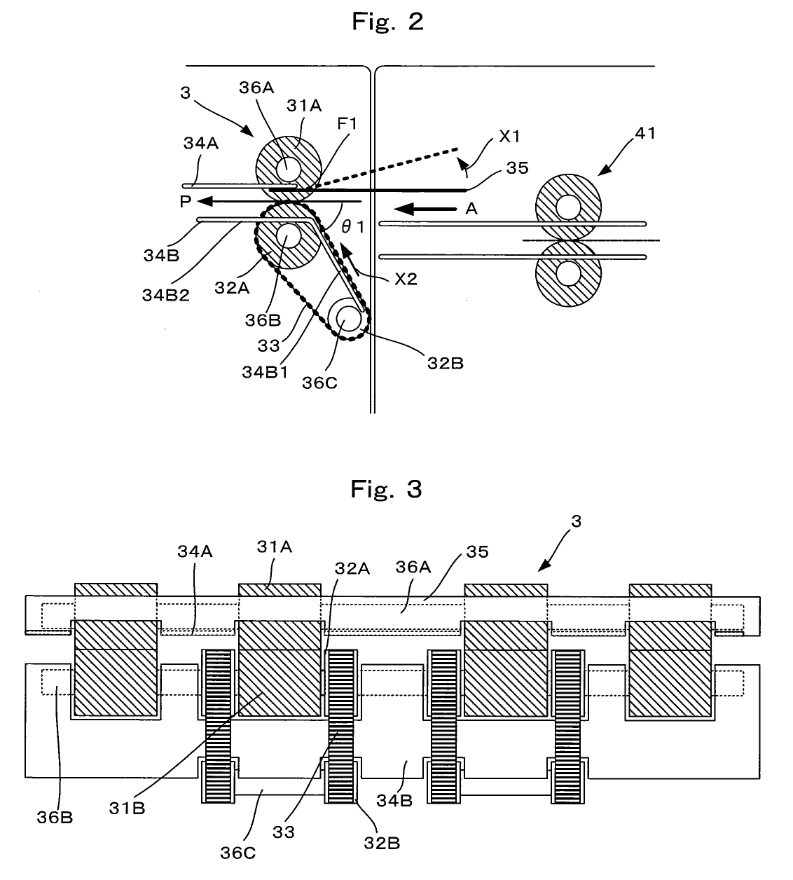

FIG. 2 is a side view of the connecting apparatus 3. FIG. 3 is a side view in which the connecting apparatus 3 is seen from an arrow A side of FIG. 2. As shown in FIG. 2 and FIG. 3, the connecting apparatus 3 includes a rotation conveyance section whose end is positioned below the recording medium discharge port of the recording medium discharging apparatus, and which is constructed separately from an inlet roller to nip and convey a recording medium and is rotated to receive the recording medium discharged from the recording medium discharging apparatus and to guide it into the inside of the recording medium receiving apparatus, and an upper conveyance mechanism whose end is positioned above the recording medium discharge port of the recording medium discharging apparatus and which is constructed separately from the inlet roller. The upper end of the connecting apparatus 3 at the recording medium discharging apparatus side is positioned above the recording medium discharge port of the recording medium discharging apparatus, and the lower end is positioned below the recording medium discharge port of the recording medium discharging apparatus.

Specifically, the connecting apparatus 3 includes inlet rollers including a drive roller 31A driven by a drive motor and a driven roller 31B which contacts the drive roller 31A and is driven, a drive shaft 36A as a rotation shaft of the drive roller 31A, and a driven shaft 36B as a rotation shaft of the driven roller 31B.

The connecting apparatus 3 further includes a first belt pulley 32A disposed on the driven shaft 36B, a freely rotating free shaft 36C, a second belt pulley 32B disposed on the free shaft 36C, and a belt 33 as a rotation conveyance section stretched between the first belt pulley 32A and the second belt pulley 32B. The belt 33 is constructed separately from the inlet rollers.

The connecting apparatus 3 further includes an upper guide plate 34A disposed below the drive shaft 36A, an inlet leading edge guide 35 disposed on the upper guide plate 34A and capable of being bent upward, and a lower guide plate 34B disposed above the driven shaft 36B and bent downward.

The upper guide plate 34A is disposed in parallel to a recording medium conveyance direction P. The upper guide plate 34A includes an inlet leading edge guide 35 as an upper conveyance mechanism at the leading edge in the recording medium entering direction.

The inlet leading edge guide 35 is provided to protrude to the image forming apparatus 1 side from the housing of the sheet finishing apparatus 2. The inlet leading edge guide 35 has a bent point F1 at a connection part to the upper guide plate 34A, is bent from the bent point F1 upward as indicated by an arrow X1 when a force is applied from below.

The belt 33 is disposed at an angle θ1 with respect to the recording medium conveyance direction. The angle θ1 is desirably 20° or more and 60° or less. In the case of less than 20°, the range of height difference capable of being absorbed becomes narrow, and in the case of larger than 60°, a probability that a jam occurs becomes high.

The belt 33 can be made of a material having high friction resistance, for example, natural rubber, chloroprene rubber or polyurethane. It desirable that the belt 33 has unevenness on the surface.

When receiving a signal indicating recording medium discharge from the image forming apparatus 1, the sheet finishing apparatus 2 rotates the belt 33 in an arrow X2 direction, that is, the recording medium conveyance direction before the recording medium is discharged.

The lower guide plate 34B includes a recording medium reception section 34B1 disposed in parallel to the belt 33, and a conveyance guide section 34B2 disposed in parallel to the recording medium conveyance direction.

When the recording medium conveyance speed of the belt 33 is Vb, the recording medium conveyance speed of the drive roller 31A and the driven roller 31B is Vr, and the recording medium discharge speed of the image forming apparatus 1 is Ve, it is desirable that the relation among the respective speeds is Vb≧Vr≧Ve from the viewpoint of jam prevention and recording medium protection.

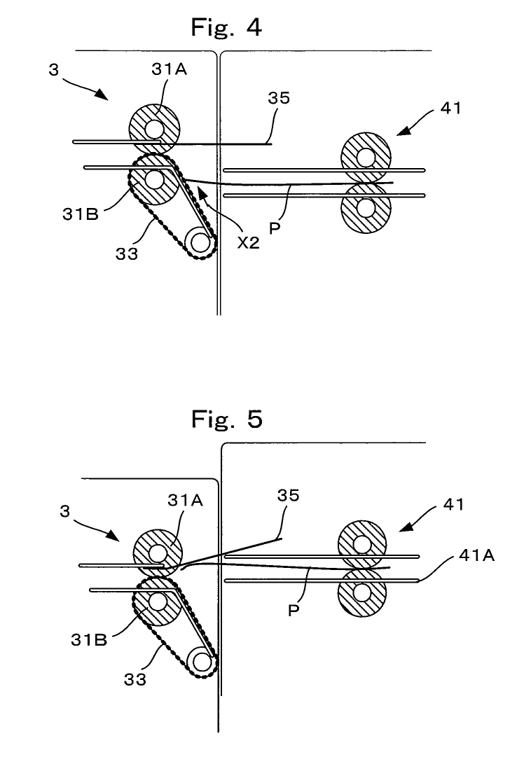

FIG. 4 is a view showing a case where the position of, the recording medium reception port of the sheet finishing apparatus 2 is higher than the position of the recording medium discharge port of the image forming apparatus 1. As shown in FIG. 4, the leading edge of the recording medium P discharged from the image forming apparatus 1 strikes the belt 33.

Here, the belt 33 rotates in the arrow X2 direction. Accordingly, the leading edge of the recording medium P is conveyed by the belt 33 to the nip position between the drive roller 31A and the driven roller 31B. The drive roller 31A and the driven roller 31B nip the conveyed recording medium P and conveys it to the inside of the sheet finishing apparatus 2.

FIG. 5 is a view showing a case where the position of the recording medium reception port of the sheet finishing apparatus 2 is lower than the position of the recording medium discharge port of the image forming apparatus 1. As shown in FIG. 5, the inlet leading edge guide 35 is lifted upward by an exit guide 41A of the image forming apparatus 1.

The leading edge of the recording medium P discharged from the image forming apparatus 1 strikes the inlet leading edge guide 35. The inlet leading edge guide 35 is inclined to the nip position between the drive roller 31A and the driven roller 31B. Accordingly, the leading edge of the recording medium P is guided to the nip position between the drive roller 31A and the driven roller 31B. The drive roller 31A and the driven roller 31B nip the conveyed recording medium P and conveys it to the inside of the sheet finishing apparatus 2.

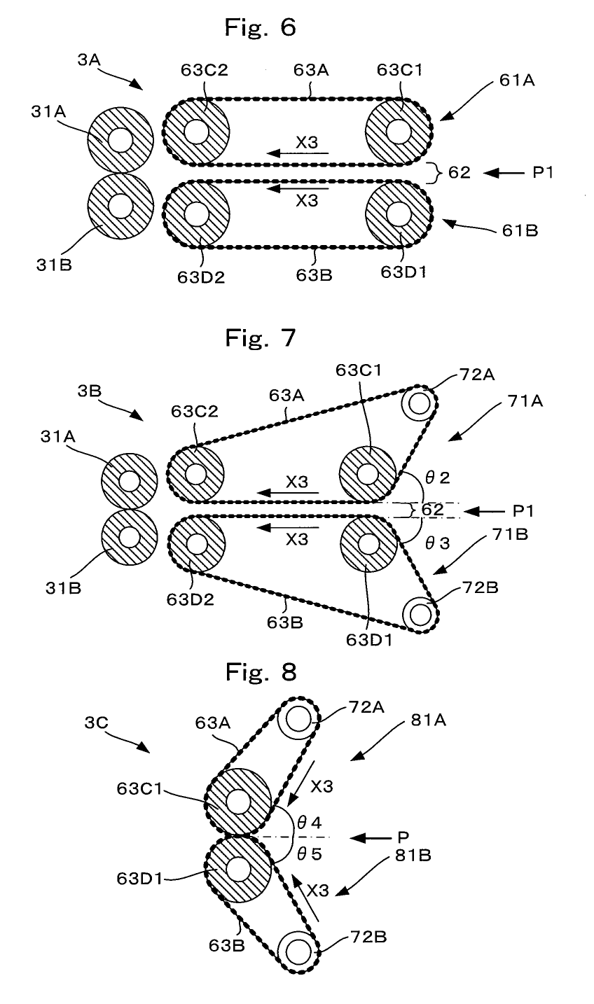

FIG. 6 is a side view of a connecting apparatus 3A of a first applied example. As shown in FIG. 6, the connecting apparatus 3A is disposed upstream of the inlet rollers 31A and 31B of the sheet finishing apparatus 2 in the recording medium conveyance direction.

The connecting apparatus 3A includes an upper conveyance mechanism 61A and a lower conveyance mechanism 61B. The upper conveyance mechanism 61A includes a belt 63A disposed in parallel to the recording medium conveyance direction P1, and a first upper pulley 63C1 and a second upper pulley 63C2 over which the belt 63A are stretched. The lower conveyance mechanism 61B includes a belt 63B disposed in parallel to the recording medium conveyance direction P1, and a first lower pulley 63D1 and a second lower pulley 63D2 over which the belt 63B is stretched.

A gap 62 is provided between the upper conveyance mechanism 61A and the lower conveyance mechanism 61B. Each of the belt 63A and the belt 63B rotates in an arrow X3 direction as the recording medium conveyance direction.

The recording medium discharged from the image forming apparatus 1 enters from the arrow P1 direction. The belt 63A and the belt 63B respectively guide the conveyed recording medium to the gap 62, and convey it to the inlet rollers 31A and 31B.

The inlet rollers 31A and 31B nip the recording medium and convey it to the inside of the sheet finishing apparatus 2.

FIG. 7 is a side view of a connecting apparatus 3B of a second applied example. As shown in FIG. 7, the connecting apparatus 3B is disposed upstream of the inlet rollers 31A and 31B of the sheet finishing apparatus 2 in the recording medium conveyance direction.

The connecting apparatus 3B includes an upper conveyance mechanism 71A and a lower conveyance mechanism 71B. The upper conveyance mechanism 71A includes a belt 63A as a rotation conveyance section, and a first upper pulley 63C1, a second upper pulley 63C2 and a third upper pulley 72A over which the belt 63A is stretched.

The belt 63A is disposed in parallel to the recording medium conveyance direction P1 between the first upper pulley 63C1 and the second upper pulley 63C2. The belt 63A is disposed at an angle θ2 with respect to the recording medium conveyance direction P between the first upper pulley 63C1 and the third upper pulley 72A.

The angle θ2 is desirably 20° or more and 60° or less. In the case of less than 20°, the range of height difference capable of being absorbed becomes narrow, and in the case of larger than 60°, a probability that a jam occurs becomes high.

The lower conveyance mechanism 71B includes a belt 63B as a rotation conveyance section, and a first lower pulley 63D1, a second lower pulley 63D2, and a third lower pulley 72B over which the belt 63B are stretched.

The belt 63B is disposed in parallel to the recording medium conveyance direction P1 between the first lower pulley 63D1 and the second lower pulley 63D2. The belt 63B is disposed at an angle θ3 with respect to the recording medium conveyance direction P between the first lower pulley 63D1 and the third lower pulley 72B.

The angle θ3 is desirably 20° or more and 60° or less. In the case of less than 20°, the range of height difference capable of being absorbed becomes narrow, and in the case of larger than 60°, a probability that a jam occurs becomes high.

A gap 62 is provided between the upper conveyance mechanism 71A and the lower conveyance mechanism 71B. Each of the belt 63A and the belt 63B rotates in an arrow X3 direction as the recording medium conveyance direction.

The recording medium discharged from the image forming apparatus 1 enters from an arrow P1 direction. The belt 63A and the belt 63B respectively guide the conveyed recording medium to the gap 62 and convey it to the inlet rollers 31A and 31B.

The inlet rollers 31A and 31B nip the recording medium and convey it to the inside of the sheet finishing apparatus 2.

FIG. 8 is a side view of a connecting apparatus 3C of a third applied example. As shown in FIG. 8, the connecting apparatus 3C is disposed at the same position as the inlet rollers 31A and 31B of the sheet finishing apparatus 2 in the recording medium conveyance direction.

The connecting apparatus 3C includes an upper conveyance mechanism 81A and a lower conveyance mechanism 81B. The upper conveyance mechanism 81A includes a belt 63A as a rotation conveyance section constructed separately from the inlet rollers, and a first upper pulley 63C1 and a third upper pulley 72A over which the belt 63A is stretched.

A surface of the belt 63A at the image forming apparatus 1 side is disposed at an angle θ4 with respect to the recording medium conveyance direction P.

The angle θ4 is desirably 20° or more and 60° or less. In the case of less than 20°, the range of height difference capable of being absorbed becomes narrow, and in the case of larger than 60°, a probability that a jam occurs becomes high.

The lower conveyance mechanism 81B includes a belt 63B as a rotation conveyance section constructed separately from the inlet rollers, and a first lower pulley 63D1 and a third lower pulley 72B over which the belt 63B is stretched.

A surface of the belt 63B at the image forming apparatus 1 side is disposed at an angle θ5 with respect to the recording medium conveyance direction P.

The angle θ5 is desirably 20° or more and 60° or less. In the case of less than 20°, the range of height difference capable of being absorbed becomes narrow, and in the case of larger than 60°, a probability that a jam occurs becomes high.

The upper conveyance mechanism 81A and the lower conveyance mechanism 81B contact each other at the periphery of the first upper pulley 63C1 and the periphery of the first lower pulley 63D1. Each of the belt 63A and the belt 63B rotates in an arrow X3 direction as the recording medium conveyance direction.

The recording medium discharged from the image forming apparatus 1 enters from the arrow P1 direction. Each of the belt 63A and the belt 63B guides the conveyed recording medium to a nip section, and conveys it to the inside of the sheet finishing apparatus 2.

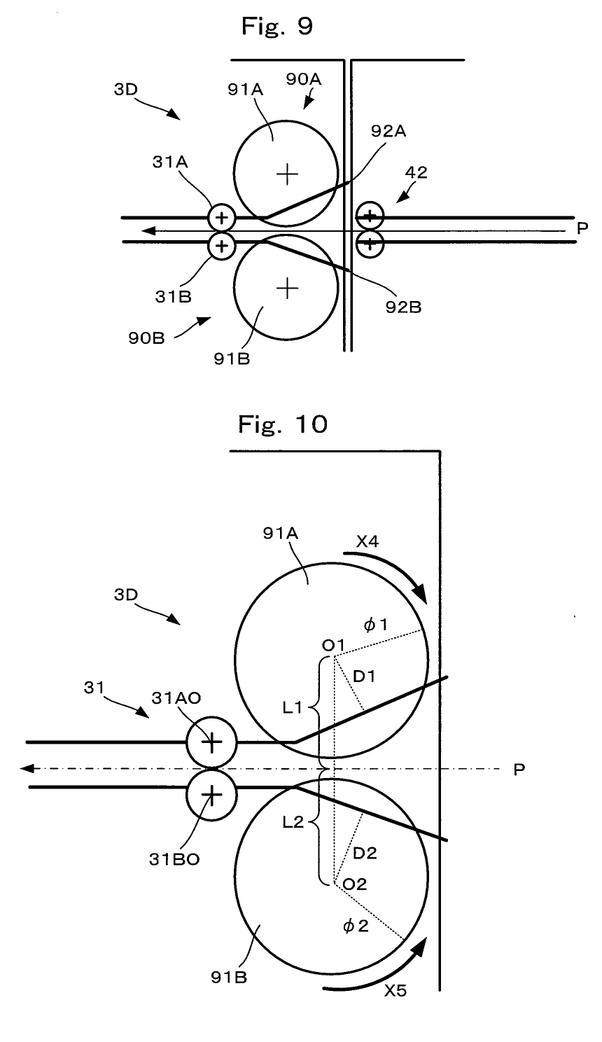

FIG. 9 is a side view of a connecting apparatus 3D of a fourth applied example. As shown in FIG. 9, the connecting apparatus 3D is disposed upstream of the inlet rollers 31A and 31B of the sheet finishing apparatus 2 in the recording medium conveyance direction. The connecting apparatus 3D includes an upper conveyance mechanism 90A and a lower conveyance mechanism 90B.

The upper conveyance mechanism 90A includes an upper guide plate 92A and an upper guide roller 91A as a rotation conveyance section constructed separately from the inlet rollers. The upper guide plate 92A has a notch, and the upper guide roller 91A is disposed in the notch. The upper guide plate 92A is bent upward at apart where the notch is positioned, and forms a taper. The leading edge of the upper guide plate 92A is positioned above a recording medium discharge section 42 of the image forming apparatus 1.

The lower conveyance mechanism 90B includes a lower guide plate 92B and a lower guide roller 91B as a rotation conveyance section constructed separately from the inlet rollers. The lower guide plate 92B has a notch, and the lower guide roller 91B is disposed in the notch. The lower guide plate 92B is bent downward at a part where the notch is positioned, and forms a taper. The leading edge of the lower guide plate 92B is positioned below the recording medium discharge section 42 of the image forming apparatus 1.

The upper guide plate 92A and the lower guide plate 92B form the taper opening toward the upstream side in the recording medium conveyance direction.

FIG. 10 is an enlarged side view of the upper guide roller 91A and the lower guide roller 91B. As shown in FIG. 10, the upper guide roller 91A and the lower guide roller 91B are arranged at positions opposite to a recording medium conveyance path P. The upper guide roller 91A and the lower guide roller 91B may be placed to be freely rotated, or may be constructed so that they are rotated by a drive section in a direction of conveying the recording medium into the sheet finishing apparatus 2.

A center O1 of the upper guide roller 91A is positioned upstream of a center 31AO of the upper inlet roller 31A in the recording medium conveyance direction and positioned above the center 31AO. A radius φ1 of the upper guide roller 91A is shorter than a distance between the center O1 of the upper guide roller 91A and the recording medium conveyance path P. A shortest distance D1 between the center O1 of the upper guide roller 91A and the upper guide plate 92A is shorter than the radius 91. A part of a curved surface of the upper guide roller 91A protrudes downward from the upper guide plate 92A.

A center O2 of the lower guide roller 91B is positioned upstream of a center 31BO of the lower inlet roller 31B in the recording medium conveyance direction and positioned below the center 31BO. A radius 92 of the lower guide roller 91B is shorter than a distance between the center O2 of the lower guide roller 91B and the recording medium conveyance path P. A shortest distance D2 between the center O2 of the lower guide roller 91B and the lower guide plate 92B is shorter than the radius φ2 of the lower guide roller 91B. Apart of a curved surface of the lower guide roller 91B protrudes upward from the lower, guide plate 92B.

When a recording medium discharged from the image forming apparatus 1 contacts the upper guide roller 91A, the upper guide roller 91A rotates in an arrow X4 direction and guides the recording medium in a direction toward the inlet rollers 31A and 31B.

When the recording medium discharged from the image forming apparatus 1 contacts the lower guide roller 91B, the lower guide roller 91B rotates in an arrow X5 direction and guides the recording medium in a direction toward the inlet rollers 31A and 31B.

As described above, the recording medium receiving apparatus includes the rotation conveyance section which is constructed separately from the inlet roller to nip and convey the recording medium, and rotates to guide the recording medium discharged from the recording medium discharging apparatus to the inside of the recording medium receiving apparatus, and includes the connecting apparatus whose upper end is positioned above the recording medium discharge port of the recording medium discharging apparatus, and whose lower end is positioned below the recording medium discharge port of the recording medium discharging apparatus.

Accordingly, the recording medium receiving apparatus including the connecting apparatus has the effect that the different in height between the recording medium discharging side apparatus and the recording medium receiving side apparatus can be absorbed.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A recording medium conveyance mechanism connecting apparatus comprising:
a rotation conveyance section whose end is positioned below a recording medium discharge port of a recording medium discharging apparatus, and which is constructed separately from an inlet roller to nip and convey a recording medium and is rotated to guide the recording medium to an inside of a recording medium receiving apparatus when the recording medium discharged from the recording medium discharging apparatus contacts the rotation conveyance section; and
an upper conveyance mechanism whose end is positioned above the recording medium discharge port of the recording medium discharging apparatus and which is constructed separately from the inlet roller.

2. The apparatus of claim 1, wherein the rotation conveyance section includes a belt.

3. The apparatus of claim 1, wherein the rotation conveyance section includes a belt made of rubber and having unevenness on a surface.

4. The apparatus of claim 1, wherein an upstream side of the rotation conveyance section in a recording medium conveyance direction is inclined downward at an angle of 20° or more and 60° or less with respect to a recording medium conveyance path.

5. The apparatus of claim 1, wherein the upper conveyance mechanism includes a belt.

6. The apparatus of claim 1, wherein an upstream side of the upper conveyance mechanism in a recording medium conveyance direction is inclined upward at an angle of 20° or more and 60° or less with respect to a recording medium conveyance path.

7. The apparatus of claim 1, wherein the rotation conveyance section includes a roller whose center is positioned upstream of and below a center of a lower inlet roller in a recording medium conveyance direction, whose radius is shorter than a distance between the center and a recording medium conveyance path, whose radius is larger than a shortest distance between the center and a lower guide plate to guide the recording medium upward, and a part of whose curved surface protrudes upward from the lower guide plate.

8. A sheet finishing apparatus comprising:
a recording medium conveyance mechanism to convey a recording medium;
a punch and staple unit to punch and staple the recording medium:
a folding unit to staple and fold the recording medium; and
a recording medium conveyance mechanism connecting apparatus including a rotation conveyance section whose end is positioned below a recording medium discharge port of a recording medium discharging apparatus, and which is constructed separately from an inlet roller to nip and convey the recording medium and is rotated to guide the recording medium discharged from the recording medium discharging apparatus to an inside of a recording medium receiving apparatus when the recording medium discharged from the recording medium discharging apparatus contacts the rotation conveyance section, and an upper conveyance mechanism whose end is positioned above the recording medium discharge port of the recording medium discharging apparatus and which is constructed separately from the inlet roller.

9. The apparatus of claim 8, wherein the rotation conveyance section includes a belt.

10. The apparatus of claim 8, wherein the rotation conveyance section includes a belt made of rubber and having unevenness on a surface.

11. The apparatus of claim 8, wherein an upstream side of the rotation conveyance section in a recording medium conveyance direction is inclined downward at an angle of 20° or more and 60° or less with respect to a recording medium conveyance path.

12. The apparatus of claim 8, wherein the upper conveyance mechanism includes a belt.

13. The apparatus of claim 8, wherein an upstream side of the upper conveyance mechanism in a recording medium conveyance direction is inclined upward at an angle of 20° or more and 60° or less with respect to a recording medium conveyance path.

14. The apparatus of claim 8, wherein the rotation conveyance section includes a roller whose center is positioned upstream of and below a center of a lower inlet roller in a recording medium conveyance direction, whose radius is shorter than a distance between the center and a recording medium conveyance path, whose radius is larger than a shortest distance between the center and a lower guide plate to guide the recording medium upward, and a part of whose curved surface protrudes upward from the lower guide plate.

15. An image forming apparatus for forming an image on a recording medium, comprising:
an electrostatic latent image carrier to carry an electrostatic latent image;
a developer supply unit to supply an image forming developer to the electrostatic latent image;
an image carrier to carry a developer image;
a fixing device to fix the developer image transferred to the recording medium from the image carrier; and
a sheet finishing apparatus including a recording medium conveyance mechanism to convey the recording medium, a punch and staple unit to punch and staple the recording medium, a folding unit to staple and fold the recording medium, and a recording medium conveyance mechanism connecting apparatus including a rotation conveyance section whose end is positioned below a recording medium discharge port of a recording medium discharging apparatus, and which is constructed separately from an inlet roller to nip and convey the recording medium and is rotated to guide the recording medium discharged from the recording medium discharging apparatus to an inside of a recording medium receiving apparatus when the recording medium discharged from the recording medium discharging apparatus contacts the rotation conveyance section, and an upper conveyance mechanism whose end is positioned above the recording medium discharge port of the recording medium discharging apparatus and which is constructed separately from the inlet roller.

16. The apparatus of claim 15, wherein the rotation conveyance section includes a belt.

17. The apparatus of claim 15, wherein an upstream side of the rotation conveyance section in a recording medium conveyance direction is inclined downward at an angle of 20° or more and 60° or less with respect to a recording medium conveyance path.

18. The apparatus of claim 15, wherein the upper conveyance mechanism includes a belt.

19. The apparatus of claim 15, wherein the rotation conveyance section includes a roller whose center is positioned upstream of and below a center of a lower inlet roller in a recording medium conveyance direction, whose radius is shorter than a distance between the center and a recording medium conveyance path, whose radius is larger than a shortest distance between the center and a lower guide plate to guide the recording medium upward, and a part of whose curved surface protrudes upward from the lower guide plate.

20. A recording medium conveying method of a recording medium conveyance mechanism connecting apparatus, comprising:
guiding a recording medium to an inside, of a recording medium receiving apparatus by rotation of a rotation conveyance section when the recording medium discharged from a recording medium discharging apparatus contacts the rotation conveyance section whose end is positioned below a recording medium discharge port of the recording medium discharging apparatus and which is constructed separately from an inlet roller to nip and convey the recording medium; and
guiding the recording medium to the inside of the recording medium receiving apparatus when the recording medium discharged from the recording medium discharging apparatus contacts an upper conveyance mechanism whose end is positioned above the recording medium discharge port of the recording medium discharging apparatus and which is constructed separately from the inlet roller.
